(19) United States
(12) Patent Application Publication
(10) Pub. No.: US 2007/0073837 A1
(43) Pub. Date: Mar. 29, 2007

(54) Online multimedia file distribution system and method

(76) Inventors: David Braydon Johnson-McCormick, Rigelesville, PA (US); Paul Cady, Bethlehem, PA (US)

Correspondence Address: DUANE MORRIS LLP, 1667 K. STREET, N.W., SUITE 700, WASHINGTON, DC, 20006-1608, US

(21) Appl. No.: 11/439,184

(22) Filed: May 24, 2006

Related U.S. Application Data
(60) Provisional application No. 60/684,123, filed on May 24, 2005.

(51) Int. Cl. G06F 15/16

(52) U.S. Cl. 709/217

(57) ABSTRACT

An online multimedia file distribution system and method applying a brokerage exchange model to peer-to-peer networks to thereby deliver a secure exchange of digital multimedia files between users and/or clients while providing payment, payment receipt and remuneration of the entity having ownership interest in the multimedia, digital rights management, and search functions.

### CLAIM OF PRIORITY

This application claims the priority of U.S. Provisional Patent Application No. 60/684,123 filed May 24, 2005, by the inventors hereof, the entirety of which is incorporated by reference herein.

### RELATED APPLICATIONS

This application is related to co-pending U.S. Patent Application Ser. No. 60/775,537 entitled “Method and System for Distributing Media Files Over a Network” filed Feb. 22, 2006, the contents of which is incorporated by reference herein.

### BACKGROUND

The present invention relates to a system and method for online multimedia distribution. More particularly, this invention relates to online multimedia distribution via hybrid peer-to-peer/client-server technology. Music, audio, video and other multimedia may be stored as digital files and may be downloaded by end users from retail computer databases or from peer-to-peer (p2p) “file sharing” databases. Such technology has developed as an alternative to traditional distribution channels for recorded multimedia. However, one problem with the use of retail computer databases is the amount of memory required to store the vast amount of multimedia data available to the general public. This results in scalability issues as database capacities limit the economic viability of such an approach. The retail computer database approach, however, provides copyright owners strict control over the distribution and remuneration pertaining to the downloading of respective multimedia content.

p2p, on the other hand affords copyright owners limited control over the distribution of their work. According to the Recording Industry of America, 2.6 billion copyrighted music files are swapped monthly over internet p2p networks. In contrast to retail computer databases, p2p file sharing databases utilize distributed storage and bandwidth to address scalability issues. While addressing the issue of scalability, prior art p2p systems possess disadvantages such as a lack of centralized management and control over p2p applications. A further methodology to address scalability issues is central processing unit (CPU) harvesting, i.e., offloading centralized functions of a server onto a client's CPU. Accordingly, the shared CPUs of p2p clients may be aggregated and the storage and bandwidth elements thereof incorporated. Prior art search engines associated with prior art p2p network repositories of multimedia files are tailored to provide precision searching and it is generally assumed that the user knows precisely what he or she needs or wants. Thus, prior art p2p systems fail to consider copyright owner remuneration and provide search capabilities for the vast repositories of files stored on the p2p databases. A need exists in the art for a hybrid p2p network that integrates a novel search functionality in connection with multimedia databases that is customizable to the needs of individual users.

Management of digital assets in a p2p network has also become an increasingly difficult challenge as digital content proliferates. The term “content” is broadly defmed herein and may include audio, video, images, electronic data, biometric information, graphics and designs, electronic documents, copyrighted materials, software, multimedia content, etc. In this document, media and content are utilized interchangeably. Enhancements in computer networking and database technology have allowed companies to manage large content collections and make the content available to third parties. While network communication provides a powerful tool to enable database managers to share content with others and facilitate access thereto, network communication makes it difficult to control and track how the content is being used.

Thus, there is a need to provide centralized management of a p2p network to thereby enable digital rights management (DRM) systems to reliably link content with additional, related data and content. The terms “link” and “linking” are defined broadly herein to include associating, pointing to, facilitating the access of, linking, connecting or connecting to, revealing a storage address of, and/or facilitating database interrogation, etc. There is also a need for DRM systems to reliably link content with related usage billing information. Generally, DRM refers to administration of users' rights (hereinafter, usage rights) in a digital environment. Prior art DRM systems use technologies (e.g., usually including encryption) to protect digital content from unauthorized use. Content associated with usage rights is sometimes referred to as “DRM-protected” or “DRM-packaged” content. One example of DRM-packaged content includes encrypted content and metadata. The metadata typically includes a DRM content identifier, related content information, and usage rules. A “public” DRM system is one that assigns, manages and controls distributed content and content for distribution (e.g., electronic downloading) to the general public consumer, whereas a “private” DRM system controls content distributed to a specific list of recipients, e.g., record label executives and music critics during a content creation process. A DRM system generally has two components, a registration DRM component and a client DRM component or system. A registration DRM component is involved in assigning usage rights to content and packaging content along with usage rights to produce DRM-packaged content, usually by a content owner, distributor or retailer. A registration DRM component may also populate a registry with usage rights. A client DRM component regulates DRM-packaged content to ensure that the content is used in accordance with associated usage rights. A client DRM component may reside and execute, e.g., on a multimedia server, and may be incorporated into or cooperate with a remote client player application or utility. Prior art methods to associate content with information about the content is to place the information in a file header or footer. Another approach to associate content with related data is to steganographically hide identifying information within the content. One such example of steganography is digital watermarking.

Digital watermarking is the science of encoding physical and electronic objects with plural-bit digital data in such a manner that the data is essentially hidden from human perception, yet can be recovered by computer analysis. Most commonly, digital watermarking is applied to multimedia such as images, audio signals, and video signals. However, it may also be applied to other types of data, including documents (e.g., through line, word or character shifting), software, multi-dimensional graphics models, and surface textures of objects. In physical objects, the data may be encoded in the form of surface texturing, or printing. Such marking can be detected from optical scan data, e.g., from a scanner, optical reader, input device, digital camera, or web cam. In electronic multimedia, the data may be encoded as slight variations in sample values. Or if the media is represented in an orthogonal domain (also termed “non-perceptual,” e.g., NPEG, DCT, wavelet, etc.), the data may be encoded as slight variations in quantization values or levels. U.S. Pat. Nos. 5,862,260, 6,122,403 and 6,614,914 are illustrative of prior art digital watermarking technologies and are each hereby incorporated by reference.

Typically, digital watermarking systems possess two primary components: an encoder that embeds the watermark in a host media signal, and a decoder that detects and reads the embedded watermark from a signal suspected of containing a watermark (e.g., a suspect signal). The encoder embeds a watermark by altering the host media signal. For example, the encoder (or embedder) component embeds a watermark by altering data samples of the media content in the spatial, temporal or some other transform domain (e.g., Fourier, Discrete Cosine, Wavelet Transform domains). The decoder component analyzes a suspect signal to detect whether a watermark is present. In applications where the watermark encodes information, the decoder extracts this information from the detected watermark. The analysis of the detected data can be accomplished in various known ways. Generally, most steganographic decoding relies on general-purpose microprocessors that are programmed by suitable software instructions to perform the necessary analysis. Other arrangements, such as using dedicated hardware, reprogrammable gate arrays, or other techniques, can of course be used.

There is, however, a need in the art to provide an online multimedia file distribution system that overcomes the scalability issues in traditional online multimedia distribution systems, prohibits illegal sharing of music files through indirect reduction of participation in illegal services, provides online content identification, provides an advance search capability for users and addresses the ownership interests of clients and other parties in multimedia content.

Accordingly, it is an object of the present disclosure to obviate many of the deficiencies in the prior art and to provide a novel online multimedia file distribution system and method.

It is therefore an object of the present disclosure to provide a novel method of providing multimedia content to users in a peer-to-peer network comprising providing a plurality of users having remote devices including available multimedia content, providing centralized control of access to the available multimedia content, and receiving requests for access to the available multimedia content from the users. The method further comprises storing the requests in the network, analyzing the requests to determine patterns of data corresponding to the available multimedia content correlated across the network, and making recommendations to at least one user as a function of the analyzed requests.

It is also an object of the present disclosure to provide a novel method for authorizing exchange of multimedia content in a distributed online network comprising the steps of providing a plurality of devices on which multimedia content may be stored, and providing a centralized administrator including a main registry on which data may be stored and adaptable to communicate with the plurality of devices. The centralized administrator reviews multimedia content provided by at least one device, verifies the legal rights of a user of the at least one device, identifies the multimedia content, updates information related to said identified content, and authorizes exchange of said multimedia content by altering the multimedia content.

It is another object of the present disclosure to provide a novel online multimedia system comprising a plurality of users having remote devices, at least one of said devices having available multimedia content, a plurality of accounts associated with the plurality of users, and a central administrator in communication with at least one of said users. The central administrator manages the plurality of accounts, authorizes the available multimedia content for exchange, responds to requests from the users, provides access to authorized content, and provides accounting functions for the users.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is an embodiment of the present disclosure providing an online multimedia file distribution system.

FIG. 2 is a representative model of an embodiment of a brokerage exchange system according to the present disclosure.

### DESCRIPTION OF PREFERRED EMBODIMENTS

With reference to the figures where like elements have been given like numerical designations to facilitate an understanding of the present invention, the various embodiments of the online multimedia file distribution system and method of the present invention are described.

According to one aspect of the present disclosure, an online multimedia file distribution system and method are disclosed for providing consumer payment and content owner remuneration as well as peer-client payment for services, digital file identification, digital file tagging, data mining, search functionality and collaborative filtering. According to a further aspect, an online multimedia file distribution system and method are disclosed for providing an online multimedia exchange brokerage, an accounting system, a search system, a privacy system, and a digital rights management system. According to another aspect, an online multimedia file distribution system and method are disclosed for providing consumer payment and content owner remuneration, digital file identification, digital file tagging, collaborative searching functionality, and digital rights management.

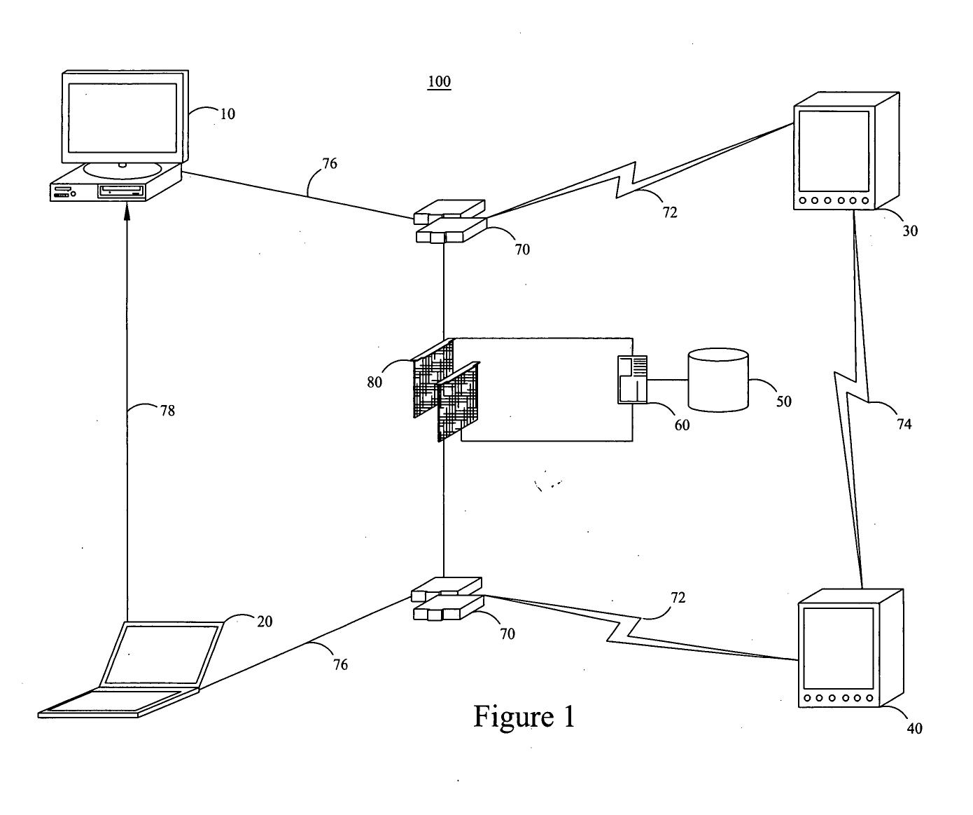

FIG. 1 is an embodiment of the present disclosure providing an online multimedia file distribution system. With reference to FIG. 1, the online multimedia file distribution system comprises a distributed network 100 including a central database 50 in continuous or intermittent communication with a plurality of multimedia servers or devices 10, 20, 30, 40 via a server environment 60, firewall 80, suitable routers 70 and communication medium such as the Internet (e.g., via a cable modem, modem or DSL), dial-up network, dedicated network, LAN, WAN, etc. The multimedia servers or devices 10, 20, 30, 40 may comprise any consumer or portable device including a central processing unit (CPU) and/or electronic processing circuitry and storage. For example, the multimedia devices may include player applications to play or render content and control software (or hardware) to carry out and support multimedia content functionality. Exemplary multimedia devices include wireless telephones and SmartPhones 30, MP3 players and personal digital assistants (PDAS) 40 such as Palm Pilots®, Pocket PC®s and iPods®, personal desktop computers 10, personal laptop and tablet computers 20, set-top boxes with suitable computing functionality, as well as other similar devices. Multimedia devices 10, 20, 30, 40 may also be in continuous or intermittent communication with other multimedia devices via wireless connections 74 or wireless connections 72 and land-line connections 76, 78. Exemplary land-line connections may be optic, DSL, POTS lines and other well known lines in the art capable of providing multimedia connectivity. Of course, the multimedia devices illustrated and described above are exemplary only and are not intended to limit the scope of the invention defmed by the claims appended hereto. For example, personal desktop computers 10 and laptop computers 20, while illustrated having a land-line communication in the network 100 may be adaptable to communicate with the network via a wireless protocol. Likewise, wireless telephones 30 and PDAs 40 may be adaptable to communicate with the network via land-line communication.

Multimedia devices may be in the possession of users, i.e., individuals who are desirous of purchasing, trading and selling multimedia content but who do not have an ownership interest in such multimedia content or in the possession of clients, i.e., individuals, companies or other entities having an ownership interest in multimedia content and are desirous of distributing such content online or through non-traditional means.

The system 100 further comprises downloadable software (not shown) adaptable to be executed by multimedia devices. The software may be delivered to the multimedia devices in a customizable XML based interface or other known interface. The software interacts with a user and/or client and provides a graphical user interface (GUI) whereby the applications provided therefrom facilitates playing, trading and/or rendering of multimedia content. It is also envisioned that such applications may be provided in hardware or firmware. The operation of the system 100 is preferably indifferent to how content stored on the multimedia devices is initially obtained and indifferent to whether the multimedia content is packaged in an encryption or other digital rights management (DRM) packages.

The central database 50 may include a plurality of distributed databases, which are synchronized or which include specific subsets of content (e.g., based on region, genre, content, etc.). In another embodiment, the central database 50 may include a plurality of p2p nodes. Database management software may be utilized to track and manage multimedia content, content identifiers, and related content. The central database 50 preferably maintains a set of usage rules. The usage rules define permitted use for multimedia content. The usage rules may be communicated to various network locations, such as the multimedia devices 10, 20, 30, 40. The multimedia devices may query the central database 50 to obtain or update usage rules, or updated rules can be pushed to the multimedia devices. Of course, the multimedia devices may also cache the usage rules locally or periodically query the central database 50 to obtain updates. The server environment 60 is adaptable to stream multimedia content to the multimedia devices for real time play or download the entire content or subset of the content to the multimedia devices. It is envisioned that some multimedia devices may be able to decrypt the content (if the content is encrypted or other DRM protected) and detect a content identifier, e.g., a digital watermark or fingerprint. Other multimedia devices may rely on the server environment 60 for decryption (if needed) and identifier detection. For example, a user of the system 100 is desirous of downloading a specific music file from the central database 50. The user logs his remote device onto the Internet, accesses a website associated with the system 100 and downloads an application onto the device. Through this process the user registers an account or his device with the system 100. The user may interact with the software through a customizable interface whereby the user may customize tool bars, menus, multimedia catalogs, playlists, member groups and associations and the characteristics thereof to his needs. Thus, by clicking on a link available on the interface, the user may download the music file from the central database. Of course, the location of the music file may reside on a remote p2p node and this example is not meant to limit the scope of the claims appended herewith.

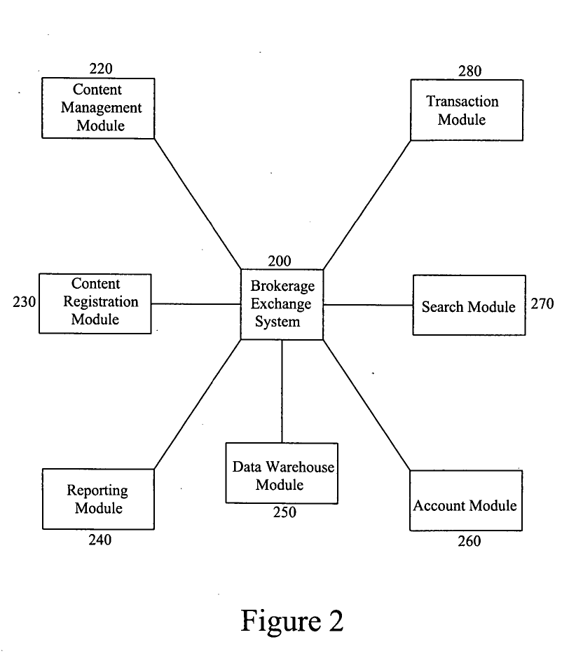

FIG. 2 is a representative model of an embodiment of a brokerage exchange system according to the present disclosure. With reference to FIG. 2, the brokerage exchange system 200 facilitates the secure purchasing, rendering, trading, selling, downloading and uploading of multimedia files between and among users and clients. The exchange brokerage system 200 may include, but is not limited to, a content management module 220, a content registration module 230, a reporting module 240, a data warehousing module 250, an account or billing module 260, a search module 270, and a transaction module 280. One or a combination of the modules may be associated or otherwise communicate with clients and users. Of course, the exchange system 200 may include further computers and/or servers, additional application support and communication software and hardware executing on the servers and/or computers to support the functionality represented by the modules.

The account or billing functions of the brokerage exchange system 200 represented by the account or billing module 260 may comprise any number or combinations of accounting functions such as credit accounting, p2p direct banking, client banking, or other banking and accounting methodologies. The exchange system 200 may be contacted periodically, when, e.g., multimedia devices report their usage, periodically, continuously or by event. The exchange system 200 provides a location where users may deposit and withdraw funds as needed. For example, when a user of the exchange system 200 sells a multimedia file, the funds collected from the transaction may be automatically credited to the user's account. Conversely, when a multimedia file is purchased, funds may be automatically debited from the user's account. The exchange system 200 is adaptable to allow both clients and users to view their current balances, account histories and other suitable account information. It is also envisioned that the exchange system 200 may allow for account interest accrual for users. Such interest may be in the form of monetary and other tangible compensation redeemable external to the system or in the form of credits and/or internal compensation redeemable within the system. Thus, users may accrue interest on a periodic basis and such interest may be automatically credited to their account. In a further embodiment of the present disclosure, funds may be placed in an escrow-type format whereby the funds are protected and interest accrues for both the user and exchange system manager.

The exchange system 200 may further integrate an incentive system whereby users receive rewards when multimedia from his/her catalog and/or playlist is sold to other users, when a user provides content reviews or transfers and sells multimedia with other users, and when multimedia exchange volume reaches pre-determined levels. For example, through the distributed network, a first user's multimedia catalog or playlist is available for sale and integrated into the search features of the system 200 by having the device turned on. Thus, transparent to the first user, a purchase of multimedia by a second user may occur based on the catalog or alternatively, a multimedia review by the first user, and the first user's account will be credited a predetermined amount. Thus, the system 200 may utilize an automated load-balancing algorithm, deciding which files to choose for fastest download speeds and based on the volume of a user's purchases, i.e., the more a user buys, the more a user is likely to sell. It is also envisioned that a user may customize his/her account to provide these rewards to outside entities such as charitable organizations, etc. or redeem these rewards external to the system 200.

With reference to FIG. 2, reporting functions of the brokerage exchange system 200 represented by the reporting module 240 may comprise any number or combinations of reporting functions and interfaces with users and/or clients. Exemplary reporting interfaces may be a web reporting interface, XML service interface, or custom interface. The reporting functions may be utilized alone or in combination with the accounting functions of the exchange system 200 to maintain and report billing, royalty billing, usage, etc. Reporting to users and clients may be accomplished by identifiers such that each participant can keep track of their own usage and billing. Usage, billing and other information may be alternatively stored in the distributed multimedia devices illustrated in FIG. 1 or may be stored utilizing the data warehousing features of the exchange system 200 represented by the data warehouse module 250. Of course, the multimedia devices may be accessed and updated to help track and maintain usage reporting and billing.

The search functions of the brokerage exchange system 200 represented by the search module 270 may include several search methodologies and functions to facilitate finding multimedia based on a plurality of profiles of the current user as well as other users. The exchange system 200 is adaptable to analyze a plurality of data and incorporate such data into search results. Thus, the search capabilities of the exchange system 200 are customizable in that the exchange system 200 incorporates searchable parameters that vary in relation to a particular user. The customizable search features are adaptable to be tailored by, but not limited to, a user's preferences and profiles, prior search results and general multimedia related to user's genre category. The search features of the exchange system 200 may alternatively include key popular search methodologies known in the art to facilitate finding multimedia that users will purchase. Thus, embodiments of the present exchange system 200 may utilize social networking filters to provide novel search results to a user and provide novel search results based on intersections between a user's multimedia selections and network or geographic trends.

Furthermore, these intersections may be utilized by the system 200 to predict dynamic growth trends both for individual multimedia content and files and for related or relevant genre. Through projection of this growth, the system 200 is able to offer multimedia recommendations with a higher relevance probability for a specific user. For example, a user of the exchange system 200 may be desirous of finding a specific type of music and enters search criteria for the blues, traditional music and before 1950. Search results provided by these filters may be numerous, however, the user may customize the search criteria and specify a geographic location such as Berkley, Calif. The search results provided by these filters will correlate patterns of music selection by users of the system across the network. Thus, a tailored and more relevant search result will be provided to the user. By way of further example, a user of the exchange system 200 may be desirous of finding a specific type of music and enters search criteria for the blues, traditional music and before 1950 while not providing any further user-inputted filters. The system 200 analyzes data related to multimedia that the user presently owns, previous multimedia searches, multimedia bought by other users having similar search criteria and multimedia catalogs or playlists and provides recommendations to the user for purchase. Of course, the system 200 may analyze further data in making recommendations to the user and the aforementioned examples should not limit the scope of the claims appended herewith.

Additionally, a further embodiment of the present system 200 may include filters that allow a first user to search multimedia present on a second user's device. For example, the first user may add the second user to the system and identify the second user as a friend. By acceptance of the aforementioned association the second user thus provides his/her multimedia, associated catalogs, playlists, etc. as multimedia content available for search to the first user and to the system 200. Alternatively, the second user may allow the first user to access to his/her member groups and associations. Furthermore, through the aforementioned association, the first user has discovered multimedia from a trusted source and may further be identified as such so that when music from the trusted source is downloaded, it may be protected by the system 200. It should be noted that depending upon the second user's trusted sources or other community network members, the second user may allow access of his/her “buddy list” or member catalog to the first user, thereby allowing the first user to access and search multimedia content owned or associated the second user's member catalog. In a further embodiment, the members of the second user's catalog may allow access to their multimedia and member catalogs and the first user may have similar or customized access thereto. Thus, embodiments according to the present disclosure may utilize multimedia filters that allow a user to search and retrieve multimedia content present on other users' devices. Furthermore, this access of other user's catalogs provides a community filter for multimedia that may be utilized by the system to provide network trends. Groups of users who are associated with each other by p2p node or member catalog/buddy lists may comprise a “network.” Of course, multiple nodes and catalogs may be complied to form this “network.” Depending upon activity between users such as multimedia files purchased and sold, volume of exchange, recommendations by users in the “network,” the system 200 will recognize these network trends in such information and related data and provide purchase recommendations accordingly. For example, a first user purchases every album released by a specific artist and provides reviews on the albums or specific songs and provides recommendations to users in his/her member catalog. Based on these recommendations and/or reviews, these users purchase single music files or albums. The system 200 will automatically credit the first user's account a pre-determined amount for the successful recommendations and will also generate purchase recommendations to some or all users in this network or node with regard to similar or relevant music. Additionally, the system 200 will mine the central database 50 for similar music, purchases, recommendations and reviews, and exchange patterns, correlate this information with the related information in the above example and provide purchase recommendations and relevant search results to unrelated users as well.

Data that may be considered by the filters, but is not limited to, include any one or combinations of the following: multimedia that a user presently owns, multimedia that a user is and has been using, a user's ratings of his/her music, multimedia purchased by the user, multimedia searched by the user, ratings of the present or related multimedia by other users, statistics of other users, usage statistics, paid result delivery by a client, community shared results and recommendations, reviews from credible sources, multimedia lists sorted by location, artist determined profiles, and previous search results and additional information related thereto. For example, a user of the exchange system 200 has completed the download of a specific multimedia file. The system may analyze the multimedia the user presently owns and offer purchase recommendations via the GUI. By way of further example, the system may analyze multimedia previously searched by the user, usage statistics of other users and the present user and community shared results to thereby offer purchase recommendations via the GUI. Thus, patterns of multimedia selections by users are correlated across the network to provide a method for predicting desired matches for specific users.

Upon analyzing the data, the exchange system 200 delivers search results to a user via direct download links based on profiles such as genre location, specific search requests, and direct agent query. Of course, while the exchange system 200 provides content that is licensed, it is well known that significant unlicensed content exists and rather than denying access thereto, links may be provided to legitimate sources of such unlicensed content. Search results may be delivered by similar user suggestion, logical association, i.e., suggestions for multimedia are provided that logically fit with the requested search, and by paid promotion, i.e., clients and users may pay for keyword associations that will get delivered at the time of user search results. Search results may also be delivered by recommendation, i.e., artists, labels, groups and users may provide recommended multimedia, or logical multimedia groupings having a basis in relevant and related search criteria, download statistics and other multimedia related data. Of course, users have the option of allowing the exchange system 200 to track their purchases and based on their usage and/or profiles, the exchange system 200 will provide suggestions on downloads. Thus, the exchange system 200 provides a customizable, automated authority on an entire catalog or distributed database of multimedia, and by analyzing a user's associated data, the exchange system 200 is adaptable to provide suggestions for purchase. Once a user locates the desired multimedia content or file, the user then may select the file for purchase and download via a click-to-buy link whereby the user's account will be automatically debited for the price of the multimedia file. The multimedia file is then transferred to the user's multimedia device or another specified location.

With reference to FIG. 2, the content management functions of the brokerage exchange system 200 represented by the content management module 220 may include validation and certification interfaces that facilitate a plurality of functions including, but not limited to, managing multimedia content on the multimedia devices through an automatic metadata search whereby the system searches against known multimedia and updates the metadata for specific multimedia content automatically. Identification of multimedia content may be accomplished by checks against certified content as well as utilizing third party fingerprinting technologies and compact disc database (CDDB) technologies, such as Gracenote® CDDB. If the third party system cannot identify the content, then the content may be manually identified and updated in the system. If the content cannot be manually identified, then the assistance of third party certified content consultants may be employed for identification purposes. Once the content has been identified, the system updates the associated metadata automatically.

For example, when multimedia content playing is requested, a multimedia device may check the content item and/or frame headers for an identifier under the centralized management of the exchange system 200. The system 200 may conduct a quality check of the multimedia content by simple file matching or identification of the content thereof through an analysis of the file name, overhead bits associated with the file, and/or header information. In one embodiment, checking for an identifier may include a watermark detection process. In a further embodiment, checking the content item may include extracting data from a file header. In still another embodiment, checking for an identifier may involve both checking header data and detecting an embedded watermark. In the case of checking a file header, if an identifier is found, and it is not part of an authenticated encryption package, it may be self-authenticated. This self-authentication process helps to ensure that the identifier has not been modified, i.e., it has not illegally copied from other multimedia content. If a header identifier is not available or trusted, the content can be searched for a watermark identifier. Watermarks are inherently trusted due to the secrecy of their embedding key and/or self-authentication features. In an alternative embodiment, a fragile watermark may be utilized to enhance the security of an identifier. A fragile watermark can be designed to be lost or to degrade predictably. Thus, when multimedia content is improperly converted or downloaded the fragile watermark may be corrupted or altered. If the multimedia content cannot be identified, the multimedia device may handle the content according to a default usage rule or in a predetermined manner defined by the exchange system 200 such as onetime play with copy restrictions. Alternatively, the multimedia devices may query the central database 50 to receive guidance. Additional levels of content security may be provided in the exchange system 200 by incorporating Microsoft Windows Media Player 10 technology (Microsoft DRM).

After multimedia content identification, the content is certified, i.e., it is ready for sale in the exchange system 200. Upon certification, the exchange system search database is updated with the known content. To prevent unauthorized content from being sold on the exchange system 200, each file in the system may be marked or fingerprinted as authorized or disallowed. This fingerprinting may be a marking of the multimedia file such as the addition of data in a header or the fingerprinting may be an extrapolation of information from the file for identification purposes. In another embodiment, the fingerprinting may be a marking of a file wrapper associated with a specific multimedia file. For example, a music file may be wrapped for security purposes by Microsoft DRM. The system 200 will fingerprint the wrapper as authorized or disallowed depending upon the content thereof. Thus, there is no alternation of the multimedia content, yet access thereto and download thereof may be centrally managed and controlled by the system 200 or a downloadable application. Of course, any fingerprinted multimedia content may be digitally altered by watermarking as well. Any file that is authorized may be sold on the system while any disallowed file is not included in the system and may not be sold. Disallowed files may include certified files that are not permitted to be sold based on licensing agreements, or any unknown or uncertified files. Since multimedia content is identified by these content identifiers (e.g., fingerprinting, digital watermarks, etc.), multimedia content may be tracked, managed, and rendered. Thus, linking an identifier to usage rules may ensure that the multimedia content can be controlled, even without an encryption package.

In yet a further embodiment of the present disclosure, direct centralized control of the exchange of multimedia may be released. For example, a first user is desirous of exchanging multimedia content with a second user. Both users are members and have registered their devices with the system 200. Upon commencement of the transaction, the users will authenticate utilizing the downloadable application required, the two devices will perform a handshake, and authorized multimedia content will be available for transfer. Data regarding the transfer will be cached in one or both of the devices. Accordingly, upon connection, periodic or otherwise, with the system 200, the cached data will be sent by the device, and the central database 50 will provide appropriate remittance and remuneration to the parties involved. If, however, the multimedia content in the exchange is not recognized by the application, an exchange thereof will not be allowed utilizing software according to the present disclosure. Of course, if the exchange between the two devices occurs while one or both are in communication with the system 200, the system 200 will monitor the exchange and data associated therewith.

In one embodiment, the exchange system 200 monitors each time that multimedia content items are accessed through content identifiers. This data may be utilized in combination with other functions provided by the exchange system 200 and represented by the search module 270, reporting module 240, accounting or billing module 260, etc. For example, the exchange system 200 may utilize the data extracted from content identifiers to facilitate billing for multimedia content consumed and used thus ensuring that entities having an ownership interest in the content and providers are properly remunerated. The exchange system 200 may also utilize content identifiers to check and track multimedia content quality by checking for degradation of the embedded data, such as through bit errors. In another embodiment, the exchange system 200 may utilize content identifiers to provide or link to other information via additional data and links maintained in the central database 50 or multimedia devices. This information may include new releases by the same artist or director, similar movies or songs, and related merchandise, etc. The exchange system 200 may also group multimedia content by metadata, i.e., genre, artist, year, etc., and create play lists for audio content based on customizable user preferences. The exchange system 200 may provide an interface for selecting or tagging multimedia content for sale, provide statistics for content such as details on the download or sales thereof, and facilitate authorization of multimedia content with the registration thereof.

The exchange system 200 may provide digital rights management (DRM) through rules that define the scope of permissible content use, e.g., such as regulating printing, viewing, copying, altering, distributing, selling, etc. Digital watermarks or fingerprinting may be utilized alone or in combination for content tracking and data management. A combination of digital watermarking and other DRM techniques may also be employed, where such techniques allow content to leave and be found outside an associated DRM package without harming the security of the system. A DRM package may be broadly defined and may include any encryption-based format, or a container in which multimedia content is securely maintained. The content identification can link the content to usage rules; thus, when such content is found outside the DRM package, it may be purchased and used, as well as re-secured, as opposed to that content being considered illegal and perhaps destroyed. Other DRM techniques adaptable for use in the exchange system 200 may incorporate encryption, digital signature and license manager technologies, and enable authentication from either a disc, online databases, p2p databases, or from PC hard drives. Such a DRM package allowing licensing in conjunction with the reporting capability of the exchange system thus providing an ideal rights management system for multimedia content. In another embodiment, the exchange system 200 may utilize metadata and/or content identifiers to provide centralized management for consistent naming of multimedia files and the updating of metadata associated therewith.

The content registration features of the exchange system 200 further provides an interface to create, house and execute licensing agreements with copyright clearing houses and for clients to register their content and create distribution agreements. The registration features provided by the exchange system 200 may further include an interface to clients that identifies current content available on p2p networks matching profiles generated by the client and that allows clients to update and register further multimedia content. Upon registration of content by the client, ownership of the multimedia content is validated. The exchange system 200 may further comprise a customizable interface to facilitate the distribution of content by clients including an account display (showing transactions and balances), content management display (showing current content available on p2p networks that matches client profiles), content registration display (showing ownership and user validation), and agreement display (showing and providing legal and business agreements and templates). For example, Sony/BMG authorizes the system 200 to exchange specific songs having copyright protection. Sony/BMG updates or completes a copyright licensing agreement available on the system and registers the songs with the system. The system 200-will identify the files, certify the content of the files and authorize the files for downloading and exchange by fingerprinting the file. This fingerprinting allows quick and accurate comparisons of a user's multimedia catalog, playlist, associated members and associated groups to a master registry contained in the central database 50.

With reference to FIG. 2, the transaction functions of the exchange system represented by the transaction module 280 provides an interface to generate revenue through the purchase of multimedia, paid search result deliveries and keyword promotions by clients, and research reports requested by clients. For example, Sony/BMG may request the statistic data regarding a specific artist. Upon request, the system 200 will mine the data contained in the central database and remote nodes, identify specific events, such as purchases, transfers and exchanges relating to the artist, associated royalty information, etc., and identify network and geographic trends. Thus, a third party may be able to utilize the existing data in the system 200 provided in a report to realize geographic and network trends related to multimedia and associate or tailor its marketing and advertising accordingly.

The exchange system 200 is adaptable to accommodate a variety of payment methodologies. For example, credit card or credit account users, i.e., PayPal, may use credit card information for payments and may deposit funds into their account as needed, or may set the account to automatically debit their credit card as their account balance dips. Well known transaction systems such as ViaKlix may be utilized for such purposes. The exchange system 200 may also accommodate clients with purchase orders or direct account users. For example, clients may utilize a purchase order or direct account debit to distribute funds to the exchange system 200 for keyword purchases, research report purchases, or other purchases that may require large funds. The exchange system 200 may alternatively utilize an XML interface including customizable application integration or enhancements having typical financial applications, i.e., PeopleSoft®.

The exchange system 200 may further accommodate cash only users, i.e., users who do not have a credit card, purchase order account or may be unwilling to use a credit card, or credit account. Serving the needs of this type of user may require several alternatives. For example, pre-paid physical cards having fixed amounts may be distributed to these users thereby permitting access to the exchange system 200 without a credit account. These pre-paid cards may be available in any number of pre-determined amounts and may be offered for sale in convenience stores, mall accessory stores, retail stores, arcades and other retail sites as well as through catalog, mail order and direct mailings. Of course, the pre-paid cards may be available online. Another alternative for these users is the transfer of funds between existing accounts. Further embodiments may utilize online deposits by third parties or direct links to utility type accounts through partnerships with telephone, cable, ISP and wireless companies. These accounts will support a chargeback system that directly debits from those companies to feed user accounts associated with the exchange system 200, and the utility companies would receive fees based on such transactions.

The exchange system 200 may possess secure protocols for transactions or portions thereof and data analyses including user authentication, music verification, certification and authorization, centralized management of user file transfers and content browsing, transaction verification, billing and payment, and other data analyses. For example, the system may require encrypted, password-driven access thereto, watermarking and fingerprinting of multimedia files, separate encryption for accounting functions and storing user data with a client rather than in the central database 50 and/or delivering statistical activity to the central database 50 without user data.

It is further envisioned by the present disclosure that the system 200 may interface with external and other p2p networks or other file sharing networks. Through this interface, the data available via nodes and databases in the p2p networks and the databases in the file sharing networks may be utilized by the present system to identify patterns of data and correlate such patterns with network and geographic trends. Thus, data and information regarding multimedia content residing external to the present system will be available to users of the present system.

As illustrated by the various embodiments disclosed above and shown in the drawings, the online multimedia file distribution system and method of the present invention applies a brokerage exchange model to p2p networks to thereby deliver a secure exchange of digital multimedia files between users and/or clients with accompanying payment, payment receipt and remuneration of the entity having ownership interest in the multimedia content while providing efficient and relevant multimedia search results to users.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method of providing multimedia content to users in a peer-to-peer network, the method comprising:
providing a plurality of users having remote devices including available multimedia content;
providing centralized control of access to the available multimedia content;
receiving requests for access to the available multimedia content from the users;
storing the requests in the network;
analyzing the requests to determine patterns of data corresponding to the available multimedia content correlated across the network; and
making recommendations to at least one user as a function of the analyzed requests.

2. The method of claim 1 wherein the pattern of data is selected from the group consisting of multimedia content that a user owns, multimedia content a user has employed, ratings of multimedia content, multimedia content purchased by a user, multimedia content searched by a user, statistics of other users, paid result delivery by a third party, community shared results, reviews, geographic location, and artist determined profiles.

3. The method of claim 1 wherein the step of analyzing further comprises evaluating correlation between the data and geographic trends.

4. The method of claim 1 wherein the step of analyzing further comprises evaluating correlation between the data and network trends.

5. A method for authorizing exchange of multimedia content in a distributed online network, the method comprising the steps of:
providing a plurality of devices on which multimedia content may be stored; and
providing a centralized administrator including a main registry on which data may be stored and adaptable to communicate with the plurality of devices, the centralized administrator:
reviewing multimedia content provided by at least one device,
verifying the legal rights of a user of the at least one device,
identifying the multimedia content,
updating information related to said identified content, and
authorizing exchange of said multimedia content.

6. The method of claim 5 wherein identifying the multimedia content further comprises recognizing the multimedia content as a function of metadata associated with said multimedia content.

7. The method of claim 5 wherein said information related to said identified content is metadata.

8. The method of claim 5 wherein said step of authorizing further comprises wrapping the multimedia content and fingerprinting the wrapper.

9. The method of claim 5 wherein said step of authorizing further comprises altering the multimedia content by a watermark.

10. The method of claim 5 further comprising the step of providing payment to an account associated with the user of the at least one device.

11. The method of claim 10 wherein said payment is tangible compensation.

12. The method of claim 10 wherein said payment is credit-base compensation.

13. The method of claim 5 further comprising the step of managing the multimedia content as a function of said alteration.

14. An online multimedia system comprising:
a plurality of users having remote devices, at least one of said devices having available multimedia content;
a plurality of accounts associated with the plurality of users; and
a central administrator in communication with at least one of said users, the central administrator managing said plurality of accounts, authorizing the available multimedia content for exchange, responding to requests from said users, providing access to authorized content, and providing accounting functions for said users.

15. The system of claim 14 wherein said accounting functions include providing payment to an account associated with ownership of exchanged content.

16. The system of claim 14 wherein said accounting functions include providing remittance to a user associated with introducing exchanged content in the system.

17. The system of claim 14 wherein said access is provided via an extensible markup language interface.

18. The system of claim 14 wherein said authorizing comprises marking said multimedia content.

19. The system of claim 18 wherein said multimedia content is marked by a fingerprint.

20. The system of claim 18 wherein said multimedia content is marked by a watermark.
